(19) United States
(12) Patent Application Publication
(10) Pub. No.: US 2026/0320511 A1
(43) Pub. Date: Oct. 15, 2026

(54) APPARATUS AND METHOD FOR ALLOCATING TASKS TO ELEVATOR AND ROBOT

(71) Applicants: Hyundai Motor Company, Seoul (KR); Kia Corporation, Seoul (KR)

(72) Inventors: Seung Hyun KANG, Hwaseong-si (KR); II Hwan HAN, Hwaseong-si (KR)

(73) Assignees: Hyundai Motor Company, Seoul (KR); Kia Corporation, Seoul (KR)

(21) Appl. No.: 19/374,838

(22) Filed: Oct. 30, 2025

(30) Foreign Application Priority Data
Apr. 10, 2025 (KR) 10-2025-0046947

(51) Int. Cl. G06Q 10/0631; B66B 1/02; G05D 1/698; G05D 101/15; G05D 105/28; G05D 107/60

(52) U.S. Cl. CPC G06Q 10/0631; B66B 1/02; G05D 1/6987; G05D 2101/15; G05D 2105/28; G05D 2107/60

(57) ABSTRACT

An apparatus for allocating tasks to an elevator and a robot, the apparatus obtains information of the elevator, information of the robot, and information of an order, pre-processes the information of the elevator, the information of the robot, and the information of the order, generates a plurality of tasks to be allocated to the elevator and the robot from the pre-processed information of the elevator, the pre-processed information of the robot, and the pre-processed information of the order, using a reinforcement learning model, and respectively allocates the plurality of tasks to the elevator and the robot.

### CROSS-REFERENCE TO RELATED APPLICATION

The present application claims the benefit of priority to Korean Patent Application No. 10-2025-0046947, filed on Apr. 10, 2025, the entire contents of which are incorporated herein by reference.

### FIELD OF THE PRESENT DISCLOSURE

The present disclosure relates to technologies for allocating tasks to an elevator and a robot.

### BACKGROUND

A multi robot task allocation (MRTA) problem may be divided into a task, a robot, and assignment. To address it, a solution may be proposed using a greedy algorithm, game theory, deep reinforcement learning (DRL), or the like.

The task may be divided into single robot tasks (ST) and multi robot tasks (MT). The ST may mean that one robot performs only one task at a time. The MT may mean that one robot simultaneously performs several tasks.

The robot may be divided into single-task robots (SR) and multi-task robots (MR). The SR may mean that one robot is required to perform one task. The MR may mean that a plurality of robots are required to perform one task.

The assignment may be divided into instantaneous assignment (IA) and time-extended assignment (TA). The IA may be a method for allocating a task to a robot immediately when the task occurs. The TA may be a method for allocating a task to a robot with a time difference to allocate the task to the robot using pieces of information of a plurality of tasks.

The DRL may be a method for combining a reinforcement learning technique and a deep neural network to learn decision making in a complex environment. The deep neural network may process a complex input as an agent is used to learn a high-level expression of a state and an action.

Multi-agent reinforcement learning (MARL) may be a method for performing learning in an environment in which agents interact with each other. Because agents have an influence on mutual actions to interact with the environment, a learning scheme may vary unlike a situation in which there is a general single agent.

Multi robot task allocation (MRTA) may refer to a process of efficiently allocating work to each robot, if a plurality of robots collaborate with each other to perform work.

In an MRTA problem, there is a situation of having to processing a plurality of orders, if there are several robots and several elevators in a multi-floor building. It is simple if immediately allocating work to a robot in this situation. However, if another order is not considered, as the robot moves several times when processing the other order delivered to the same place, a total delivery time delay may become longer. Due to this, it is important to effectively process multiple orders in an environment in which there are a plurality of elevators and a plurality of robots.

However, an existing technology does not consider a situation (MT-MR-TA) in which several orders are considered and a delivery robot or an elevator performs several tasks at a time, in the situation in which there are the plurality of elevators and the plurality of robots. Thus, as a waiting time occurs because collaboration between an elevator and a robot is not correctly performed although there is an available elevator, a total delivery time becomes longer.

### BRIEF SUMMARY

The present disclosure has been made to solve the above-mentioned problems occurring in the related art while advantages achieved by the related art are maintained intact.

Various aspects of the present disclosure are directed to providing an apparatus and a method for allocating tasks to an elevator and a robot to efficiently control a delivery robot system in a multi-floor building.

The technical problems to be solved by the present disclosure are not limited to the aforementioned problems, and any other technical problems not mentioned herein will be clearly understood from the following description by those skilled in the art to which the present disclosure pertains.

According to various aspects of the present disclosure, an apparatus for allocating tasks to an elevator and a robot may include a processor, a memory, and a communication device. The processor may obtain information of the elevator, information of the robot, and information of an order, may pre-process the information of the elevator, the information of the robot, and the information of the order, may generate a plurality of tasks to be allocated to the elevator and the robot from the pre-processed information of the elevator, the pre-processed information of the robot, and the pre-processed information of the order, using a reinforcement learning model, and may respectively allocate the plurality of tasks to the elevator and the robot.

According to various aspects of the present disclosure, the processor may manage the information of the elevator and the information of the robot as a list and may update and manage the list if a problem or an event occurs, if obtaining the information of the elevator, the information of the robot, and the information of the order.

According to various aspects of the present disclosure, the processor may sort and manage the information of the order in a queue depending on a priority and a request time of the order, if obtaining the information of the elevator, the information of the robot, and the information of the order.

According to various aspects of the present disclosure, each of the information of the elevator and the information of the robot may include whether it is possible to operate, a location, whether to proceed with work, and a loadable amount. The information of the order may include a priority, an order product, an amount, a receiving place, and a delivery place of the order.

According to various aspects of the present disclosure, the processor may generate a worker data list which is a list of an available elevator and an available robot capable of working, based on the information of the elevator and the information of the robot, if pre-processing the information of the elevator, the information of the robot, and the information of the order, and may generate a task data list including a task to be performed by each of the available elevator and the available robot, based on the information of the order.

According to various aspects of the present disclosure, the task data list may include an order number, a type of a performance target, a behavior of the performance target, a loaded item, and an amount for the item for each task.

According to various aspects of the present disclosure, the processor may input the worker data list and the task data list to the reinforcement learning model to generate the plurality of tasks to be allocated to the available elevator and the available robot, if generating the plurality of tasks to be allocated to the elevator and the robot.

According to various aspects of the present disclosure, the reinforcement learning model may be pre-trained to allocate multiple tasks using a proximal policy optimization (PPO)-based deep reinforcement learning algorithm.

According to various aspects of the present disclosure, a reward function of the PPO-based deep reinforcement learning algorithm may include a total time delay (TTD) and a reward adjustment factor according to the TTD.

According to various aspects of the present disclosure, the processor may update a state in which the elevator and the robot currently perform the tasks, after generating the plurality of tasks to be allocated to the elevator and the robot.

According to various aspects of the present disclosure, a method for allocating tasks to an elevator and a robot may include obtaining information of the elevator, information of the robot, and information of an order, pre-processing the information of the elevator, the information of the robot, and the information of the order, generating a plurality of tasks to be allocated to the elevator and the robot from the pre-processed information of the elevator, the pre-processed information of the robot, and the pre-processed information of the order, using a reinforcement learning model, and respectively allocating the plurality of tasks to the elevator and the robot.

According to various aspects of the present disclosure, the obtaining of the information of the elevator, the information of the robot, and the information of the order may include managing the information of the elevator and the information of the robot as a list and updating and managing the list, if a problem or an event occurs.

According to various aspects of the present disclosure, the obtaining of the information of the elevator, the information of the robot, and the information of the order may include sorting and managing the information of the order in a queue depending on a priority and a request time of the order.

According to various aspects of the present disclosure, the pre-processing of the information of the elevator, the information of the robot, and the information of the order may include generating a worker data list which is a list of an available elevator and an available robot capable of working, based on the information of the elevator and the information of the robot and generating a task data list including a task to be performed by each of the available elevator and the available robot, based on the information of the order.

According to various aspects of the present disclosure, the generating of the plurality of tasks to be allocated to the elevator and the robot may include inputting the worker data list and the task data list to the reinforcement learning model to generate the plurality of tasks to be allocated to the available elevator and the available robot.

According to various aspects of the present disclosure, the method may further include updating a state in which the elevator and the robot currently perform the tasks, after generating the plurality of tasks to be allocated to the elevator and the robot.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of a system for allocating tasks to an elevator and a robot according to an exemplary embodiment of the present disclosure;

FIG. 2, FIG. 3, and FIG. 4 are flowcharts illustrating a method for allocating tasks to an elevator and a robot according to an exemplary embodiment of the present disclosure;

FIG. 5 is a drawing illustrating information of an elevator, information of a robot, and information of an order according to an exemplary embodiment of the present disclosure;

FIG. 6 is a drawing illustrating a worker data list and a task data list according to an exemplary embodiment of the present disclosure;

FIG. 7 is a drawing illustrating a process of generating a plurality of tasks using a reinforcement learning model according to an exemplary embodiment of the present disclosure;

FIG. 8 is a drawing illustrating a method for allocating tasks to an elevator and a robot according to another exemplary embodiment of the present disclosure;

FIG. 9 is a drawing illustrating the entire process of allocating and delivering tasks to an elevator and a robot according to an exemplary embodiment of the present disclosure; and

FIG. 10 illustrates a computing system according to an exemplary embodiment of the present disclosure.

### DETAILED DESCRIPTION

Hereinafter, various exemplary embodiments of the present disclosure will be described in detail with reference to the exemplary drawings. In adding the reference numerals to the components of each drawing, it should be noted that the identical component is designated by the identical numerals even when they are displayed on other drawings. Furthermore, in describing the exemplary embodiment of the present disclosure, a detailed description of well-known features or functions will be ruled out in order not to unnecessarily obscure the gist of the present disclosure.

In describing the components of the exemplary embodiment according to an exemplary embodiment of the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The term used in the specification is interpreted as including both of a plural form and a singular form, if there is no separate definition.

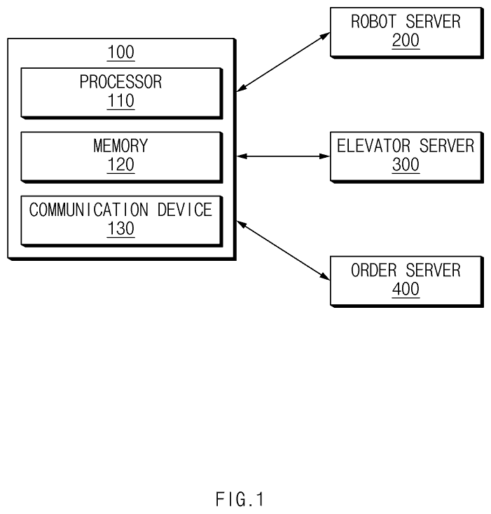

Hereinafter, various exemplary embodiments of the present disclosure will be described in detail with reference to FIGS. 1 to 10.

FIG. 1 is a block diagram illustrating a configuration of a system for allocating tasks to an elevator and a robot according to an exemplary embodiment of the present disclosure.

Referring to FIG. 1, the system may include a computing device 100 for allocating tasks to an elevator and a robot, a robot server 200, an elevator server 300, and an order server 400. However, the components of the system are not limited thereto and a component may be omitted or added if necessary. For example, the system may include only one computing device to allocate the tasks to the elevator and the robot via the one computing device.

The computing device 100 for allocating the tasks to the elevator and the robot may be a computable computing device. For example, the computing device 100 for allocating the tasks to the elevator and the robot may include a processor 110, a memory 120, and a communication device 130. According to various exemplary embodiments of the present disclosure, the components of the computing device 100 are not limited to those shown in FIG. 1 and some components may be further added or omitted. As an exemplary embodiment of the present disclosure, the computing device 100 may further include an output device. For example, the output device of the computing device 100 may include a display. The display may visually display information about a task.

In an exemplary embodiment of the present disclosure, the processor 110 may be composed of one or more cores and may include a processor for performing an operation associated with data processing, for example, a central processing unit (CPU), a general purpose graphics processing unit (GPGPU), or a tensor processing unit (TPU) of the computing device 100.

The processor 110 may perform computation for training of an artificial intelligence-based model. For example, the processor 110 may perform determination in learning (e.g., deep reinforcement learning (DRL), multi-agent reinforcement learning (MARL), or the like) in deep learning. Furthermore, in an exemplary embodiment of the present disclosure, the processor 110 may use processors of a plurality of computing devices together to perform training of an artificial intelligence model and data processing of the artificial intelligence model.

The processor 110 may usually control the overall operation of the computing device 100. The processor 110 may process a signal, data, information, or the like input or output via the components included in the computing device 100 or may run an application program stored in the memory 120, thus providing or processing appropriate information or an appropriate function to a user.

In an exemplary embodiment of the present disclosure, the memory 120 may store any type of information generated or determined by the processor 110 and/or any type of information received by the communication device 130. The memory 120 may operate by the processor 110.

The memory 120 may include at least one type of storage medium among a flash memory type memory, a hard disk type memory, a multimedia card micro type memory, a card type memory (e.g., an SD or XD memory or the like), a random access memory (RAM), a static RAM (SRAM), a read-only memory (ROM), an electrically erasable programmable ROM (EEPROM), a programmable ROM (PROM), a magnetic memory, a magnetic disc, and/or an optical disc. The computing device 100 may operate in conjunction with web storage for performing a storage function of the memory 120 on the Internet. The above-mentioned description of the memory 120 is only an example and the present disclosure is not limited thereto.

The communication device 130 may include any wired and wireless communication network configured for transmitting and receiving any type of data, information, signal, and the like. The communication device 130 may communicate with an external device. The external device may include, for example, a robot server 200, an elevator server 300, an order server 400, and the like.

The robot server 200 may be a server for controlling and managing a robot. The robot server 200 may receive data from the robot. For example, the robot server 200 may receive whether it is possible to operate, a location, whether to proceed with work, a loadable amount, or the like from the robot. The robot server 200 may transmit the data received from the robot to the computing device 100. If receiving the task of the robot from the computing device 100, the robot server 200 may allocate the received task to the robot.

The elevator server 300 may be a server for controlling and managing an elevator. The elevator server 300 may receive data from the elevator. For example, the elevator server 300 may receive whether it is possible to operate, a location, whether to proceed with work, a loadable amount, or the like from the elevator. The elevator server 300 may transmit the data received from the elevator to the computing device 100. If receiving the task of the elevator from the computing device 100, the elevator server 300 may allocate the received task to the elevator.

The order server 400 may be a server for managing data about order input by the user. The data about the order may include a priority, an order product, an amount, a receiving place, a delivery place, or the like of the order. The order server 400 may transmit the data about the order to the computing device 100.

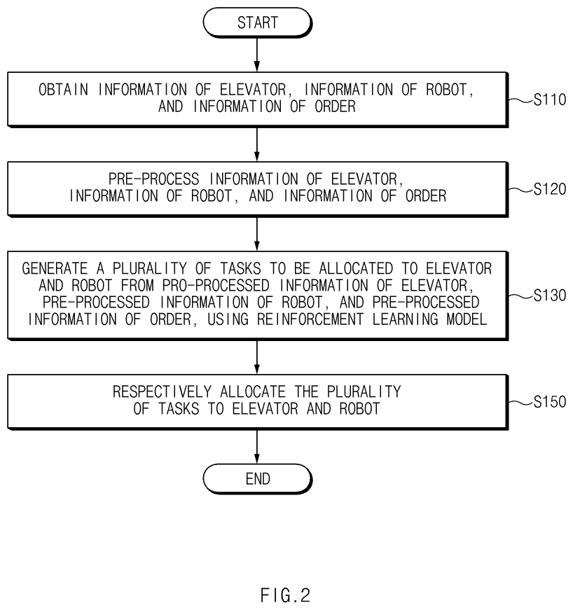

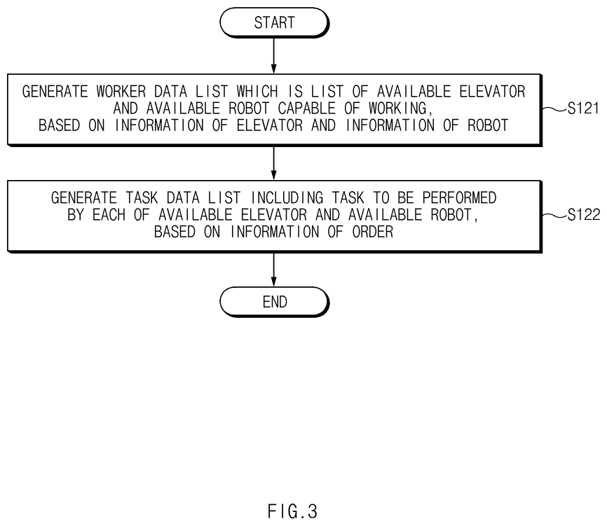

Hereinafter, a description will be given in detail of a method for allocating tasks to an elevator and a robot according to an exemplary embodiment of the present disclosure with reference to FIG. 2, FIG. 3 and FIG. 4. FIG. 2, FIG. 3 and FIG. 4 are flowcharts illustrating a method for allocating tasks to an elevator and a robot according to an exemplary embodiment of the present disclosure. Steps of FIG. 2, FIG. 3 and FIG. 4 may be performed by a computing device 100 for allocating tasks to an elevator and a robot.

Referring to FIG. 2, in S110, the computing device 100 may obtain information of an elevator, information of a robot, and information of an order.

In an exemplary embodiment of the present disclosure, the computing device 100 may manage the information of the elevator and the information of the robot as a list and may update and manage the list, if a problem or an event occurs, such as a situation where the elevator cannot move or where the completion time of a delivery task is extended.

In an exemplary embodiment of the present disclosure, each of the information of the elevator and the information of the robot may include whether it is possible to operate, a location, whether to proceed with work, and a loadable amount.

In an exemplary embodiment of the present disclosure, the computing device 100 may sort and manage the information of the order in a queue depending to a priority and a request time.

In an exemplary embodiment of the present disclosure, the queue may be a data structure for processing data in a first-in-first-out (FIFO) scheme. In other words, the queue may have a structure in which data first input to the queue is first output. Thus, the queue may be used in the situation of having to sequentially process the information of the order.

In an exemplary embodiment of the present disclosure, the information of the order may include a priority, an order product, an amount, a receiving place, and a delivery place of the order.

In S120, the computing device 100 may pre-process the information of the elevator, the information of the robot, and the information of the order. In an exemplary embodiment of the present disclosure, the computing device 100 may pre-process the information of the order by the predetermined maximum number of allocation orders. In an exemplary embodiment of the present disclosure, the computing device 100 may accumulate order information during a certain time and may pre-process the entire data, if the order information stored in the queue reaches a certain size or a certain time elapses.

For example, referring to FIG. 3, in S121, the computing device 100 may generate a worker data list which is a list of an available elevator and an available robot capable of working, based on the information of the elevator and the information of the robot.

In S122, the computing device 100 may generate a task data list including a task to be performed by each of the available elevator and the available robot, based on the information of the order.

In an exemplary embodiment of the present disclosure, the task data list may include an order number, a type of a performance target, a behavior of the performance target, an accumulated item, an amount for the item, or the like for each task.

In an exemplary embodiment of the present disclosure, the type of the performance target may be a type (e.g., a robot or an elevator) of an object to perform a task, without referring to a detailed specific object to perform the task.

Referring again to FIG. 2, in S130, the computing device 100 may generate a plurality of tasks to be allocated to the elevator and the robot from the pre-processed information of the elevator, the pre-processed information of the robot, and the pre-processed information of the order, using the reinforcement learning model.

In an exemplary embodiment of the present disclosure, the computing device 100 may input the worker data list and the task data list to the reinforcement learning model to generate the plurality of tasks to be allocated to the available elevators and the available robots.

In an exemplary embodiment of the present disclosure, the reinforcement learning model may be pre-trained to allocate multiple tasks using a proximal policy optimization (PPO)-based on deep reinforcement learning algorithm.

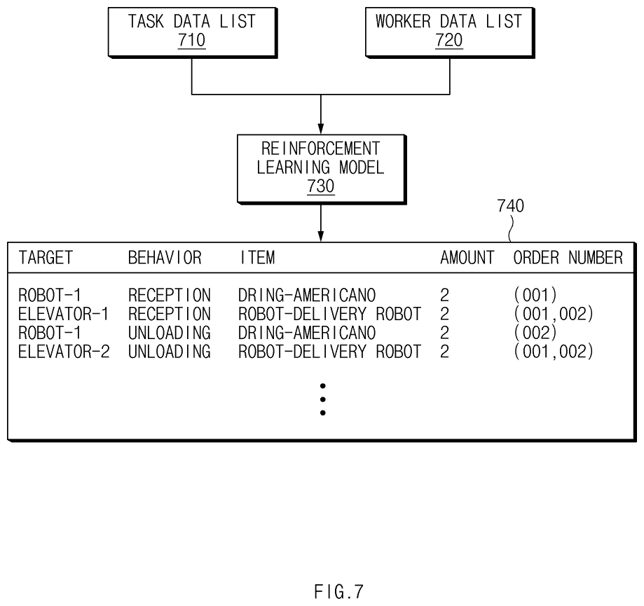

In an exemplary embodiment of the present disclosure, a reward function of the PPO-based deep reinforcement learning algorithm may include a total time delay (TTD) and a reward adjustment factor according to the TTD. A detailed description of the reinforcement learning model will be given in detail below with reference to FIG. 7.

In an exemplary embodiment of the present disclosure, referring to FIG. 4, after generating (S130) the plurality of tasks to be allocated to the elevator and the robot, in S140, the computing device 100 may update a state in which the elevator and the robot currently perform the tasks.

The computing device 100 may update the state in which the tasks are currently performed before respectively allocating the plurality of tasks to the elevator and the robot, thus efficiently allocating the tasks,

Referring again to FIG. 2, in S150, the computing device 100 may respectively allocate the plurality of tasks to the elevator and the robot.

For example, the computing device 100 may allocate a first task to a first elevator, may allocate a second task to a second elevator, may allocate a third task to a third elevator, and may allocate a fourth task to a fourth robot. Thus, if there are several robots and several elevators, the computing device 100 may process a plurality of orders.

In an exemplary embodiment of the present disclosure, the computing device 100 may transmit a signal indicating that the order starts to be processed to the order server 400. The order server 400 may receive the signal indicating that the order starts to be processed from the computing device 100 and may perform an additional action. For example, the order server 400 may transmit data about a newly collected order to the computing device 100.

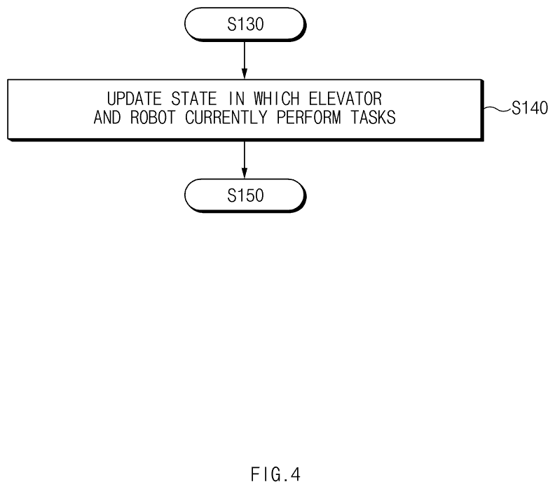

FIG. 5 is a drawing illustrating information of an elevator, information of a robot, and information of an order according to an exemplary embodiment of the present disclosure. Contents duplicated with the contents described above via FIG. 1, FIG. 2, FIG. 3, and FIG. 4 may be omitted from contents which will be described below with reference to FIG. 5.

Referring to FIG. 5, information 510 of an elevator may include data on each of a plurality of elevators. For example, the information 510 of the elevator may include elevator 1 data, elevator 2 data, elevator 3 data, or the like.

In an exemplary embodiment of the present disclosure, each of the elevator 1 data, the elevator 2 data, and the elevator 3 data may include whether it is possible to operate, a location, whether to proceed with work, a loadable amount, and the like. For example, the elevator 1 data may include “whether it is possible to operate: TRUE, the location: 1F, whether to process with the work: READY, and the loadable amount: 0/2”.

In an exemplary embodiment of the present disclosure, information 520 of a robot may include data on each of a plurality of robots. For example, the information 520 of the robot may include robot 1 data, robot 2 data, robot 3 data, and the like.

In an exemplary embodiment of the present disclosure, each of the robot 1 data, the robot 2 data, and the robot 3 data may include whether it is possible to operate, a location, whether to proceed with work, a loadable amount, and the like. For example, the robot 1 data may include “whether it is possible to operate: TRUE, the location: 1F, whether to process with the work: READY, and the loadable amount: 0/100%”.

In an exemplary embodiment of the present disclosure, information 530 of an order may include data on each of a plurality of orders. For example, the information 530 of the order may include order 1 data, order 2 data, order 3 data, order 4 data, and the like.

In an exemplary embodiment of the present disclosure, each of the order 1 data, the order 2 data, the order 3 data, and the order 4 data may include a priority, an order product, an amount, a receiving place, a delivery place, and the like. For example, the order 1 data may include “the priority: 0, the order product: A, the amount: 2, and the location (reception, delivery): 2F”.

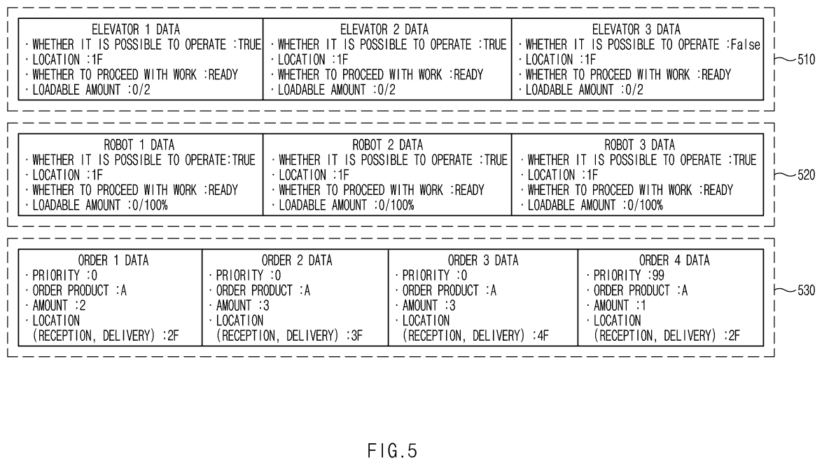

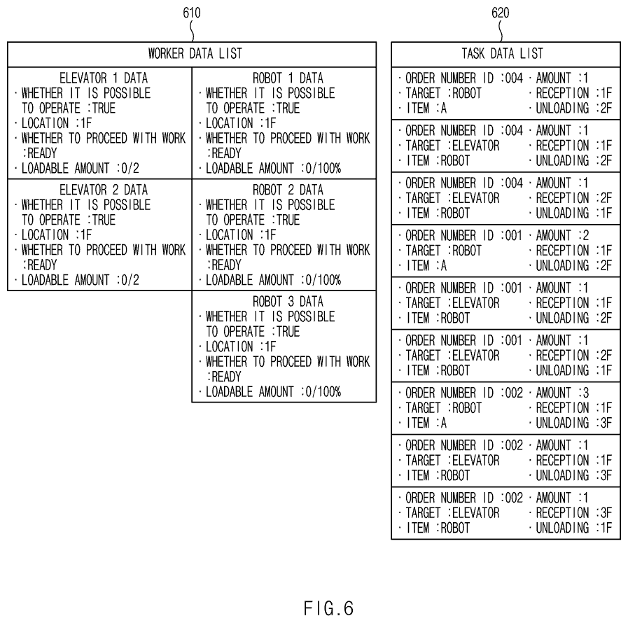

FIG. 6 is a drawing illustrating a worker data list and a task data list according to an exemplary embodiment of the present disclosure. Contents duplicated with the contents described above via FIG. 1, FIG. 2, FIG. 3, FIG. 4, and FIG. 5 may be omitted from contents which will be described below with reference to FIG. 6.

Referring to FIG. 6, a worker data list 610 may include data on an available elevator and an available robot capable of working in information of the elevator and information of the robot.

In an exemplary embodiment of the present disclosure, the available elevator and/or the available robot may be an elevator and/or a robot in which it is TRUE in a condition for whether it is possible to operate. For example, data of elevator 1 which is the available elevator may include “whether it is possible to operate: TRUE, the location: IF, whether to process with the work: READY, and the loadable amount: 0/2”. For another example, data of robot 1 which is the available robot may include “whether it is possible to operate: TRUE, the location: IF, whether to process with the work: READY, and the loadable amount: 0/100%”.

In an exemplary embodiment of the present disclosure, a task data list 620 may include data on a task to be performed by each of the available elevator and the available robot based on information of an order. For example, a first task included in the task data list 620 may be “the order number ID: 004, the amount: 1, the target: robot, the reception: 1F, the item: A, and the unloading: 2F”.

FIG. 7 is a drawing illustrating a process of generating a plurality of tasks using a reinforcement learning model according to an exemplary embodiment of the present disclosure. Contents duplicated with the contents described above via FIG. 1, FIG. 2, FIG. 3, FIG. 4, FIG. 5 and FIG. 6 may be omitted from contents which will be described below with reference to FIG. 7.

Referring to FIG. 7, in an exemplary embodiment of the present disclosure, a computing device 100 may input a task data list 710 and a worker data list 720 to a reinforcement learning model 730 to generate a plurality of tasks 740 to be allocated to an elevator and a robot.

In an exemplary embodiment of the present disclosure, the reinforcement learning model 730 may allocate tasks to a specific robot and a specific elevator in a situation where there are “multi robot tasks (MT)”-“multi-task robots (MR)”-“time-extended (TA)” and a multi-agent using a proximal policy optimization (PPO)-based deep reinforcement learning algorithm.

A state St of each agent in the deep reinforcement learning algorithm may be represented as Equation 1 below.

Sₜ={p₁,pᵣ,c₁,cᵣ,bᵣ,b_{d}} <Equation 1>
p₁: elevator location
pᵣ: robot location
c₁: allowable capacity of elevator (ex) 1, number of robots
cᵣ: allowable capacity of robot (ex) 30%
bᵣ: battery of robot (ex) 85%
b_{d}: task data list

An action at each agent is able to take may be represented as Equation 2 below.

aₜ={aₗ,aᵣ} <Equation 2>
aₗ action of elevator (move, stop, get on, get off)
aᵣ: action of robot (move, stop, get on, get off)

A reward function r(sₜ, aₜ) in the deep reinforcement learning algorithm may be represented as Equation 3 below with regard to success in delivery and a total time delay (TTD).

$$r ( {s}_{t} , {a}_{t} ) = \{ \begin{matrix}+ 1 - α \cdot TTD ( success in delivery ) \\ - 1 - α \cdot TTD ( failure in delivery ) \\ - α \cdot TTD ( others )\end{matrix} \} \qquad 〈 Equation 3 〉$$

TTD: total time delay
α: reward adjustment factor according to time delay

In an exemplary embodiment of the present disclosure, the TTD may refer to a time taken in an environment in which there are multiple elevators and multiple robots.

In an exemplary embodiment of the present disclosure, a reward adjustment factor according to a time delay may be predetermined. For example, the reward adjustment factor α according to the time delay may be predetermined as 0.2. However, the value of the reward adjustment factor is not limited thereto, which may be varied.

A policy in the deep reinforcement learning algorithm may be represented as Equation 4 below.

π_{θ}(aₜ|sₜ)=P(Aₜ₌aₜ|sₜ=sₜ;θ) <Equation 4>
θ: policy network parameter

In an exemplary embodiment of the present disclosure, the policy may refer to a function or a rule for determining whether an agent selects a certain action in a given state.

A value function V_{Ø} in the deep reinforcement learning algorithm may be represented as Equation 5 below.

$${V}_{∅} ( {s}_{t} ) = E [ {\sum }_{t = 0}^{∞} {γ}_{t} {r}_{t} \vert {S}_{t} ; ∅ ] \qquad 〈 Equation 5 〉$$

Ø: value network parameter
γₜ: discount factor

A clipping loss function L^{CLIP} in the deep reinforcement learning algorithm may be represented as Equation 6 below.

L^{CLIP}(θ)=Eₜ[min(rₜ(θ) [symbol] ,clip(rₜ(θ),1−ϵ,1+ϵ) [symbol] ] <Equation 6>

$${r}_{t} ( θ ) = \frac{{π}_{θ} ( {a}_{t} \vert {s}_{t} )}{- {π}_{{θ}_{old}} ( {a}_{t} \vert {s}_{t} )} :$$

ratio between current policy and previous policy
[symbol] : estimated advantage function
ϵ: clipping range (ex: 0.2)

In an exemplary embodiment of the present disclosure, clipping is a method for limiting a change in policy, which may limit a probability ratio between a new policy and a previous policy to a specific range.

In an exemplary embodiment of the present disclosure, the clipping range ∈ which is a hyperparameter of the deep reinforcement learning algorithm may be variably used according to an environment.

An advantage function Âₜ in the deep reinforcement learning algorithm may be represented as Equation 7 below.

$${\hat{A}}_{t} = {\sum }_{l = 0}^{∞} {( γ λ )}^{l} {δ}_{t + 1} \qquad 〈 Equation 7 〉$$

$${δ}_{t} = {r}_{t} + γ {V}_{∅} ( {s}_{t} + 1 ) - {V}_{∅} ( {s}_{t} )$$

λ: hyperparameter used when calculating the advantage function

In an exemplary embodiment of the present disclosure, the advantage function may be a function for measuring how much better (or worse) a specific action is than the average action.

In an exemplary embodiment of the present disclosure, the plurality of tasks 740 to be allocated to the elevator and the robot may include a detailed target (e.g., a first robot, a second robot, a first elevator, or the like) to perform a task for each task, a behavior (e.g., reception, unloading, or the like), an item (e.g., drink, a robot, or the like), an amount for the item, an order number, or the like.

In an exemplary embodiment of the present disclosure, the plurality of tasks 740 to be allocated to the elevator and the robot may be action data.

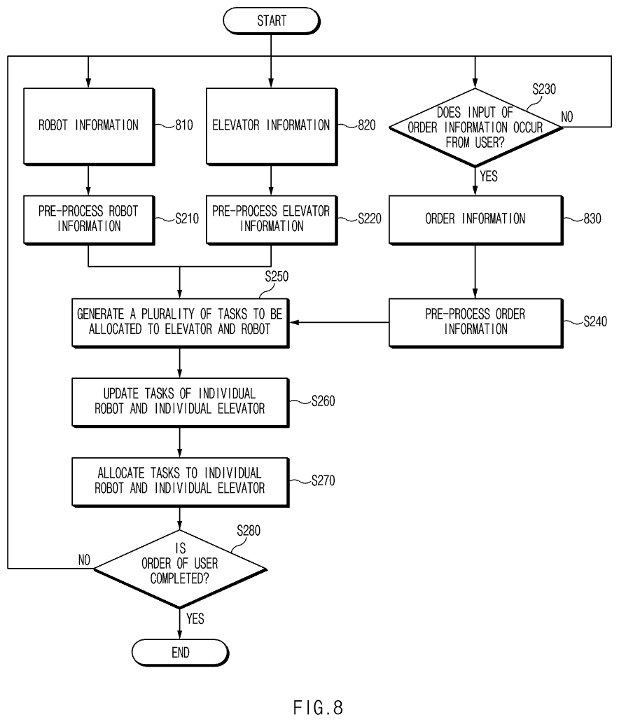

FIG. 8 is a drawing illustrating a method for allocating tasks to an elevator and a robot according to another exemplary embodiment of the present disclosure. Contents duplicated with the contents described above via FIGS. 1 to 7 may be omitted from contents which will be described with reference to FIG. 8.

Referring to FIG. 8, if robot information 810 is collected, obtained, received, or input, in S210, a computing device 100 may pre-process the robot information 810.

Referring to FIG. 8, if elevator information 820 is collected, obtained, received, or input, in S220, the computing device 100 may pre-process the elevator information 820.

In an exemplary embodiment of the present disclosure, if the input of order information 830 does not occur from a user in S230 (NO), the computing device 100 may wait until the order information 830 is input. In the instant case, the computing device 100 may continuously collect, obtain, receive, or input the robot information 810 and the elevator information 820.

In an exemplary embodiment of the present disclosure, if the input of the order information 830 occurs from the user in S230 (YES), in S240, the computing device 100 may pre-process the order information 830.

In an exemplary embodiment of the present disclosure, in S250, the computing device 100 may generate a plurality of tasks to be allocated to an elevator and a robot, on the basis of the pre-processed robot information, the pre-processed elevator information, and the pre-processed order information. For example, the computing device 100 may generate the plurality of tasks to be allocated to the elevator and the robot from the pre-processed robot information, the pre-processed elevator information, and the pre-processed order information, using a reinforcement learning model.

In an exemplary embodiment of the present disclosure, in S260, the computing device 100 may update tasks of an individual robot and an individual elevator. For example, the computing device 100 may update the tasks depending on whether the individual robot and the individual elevator currently perform the tasks.

In an exemplary embodiment of the present disclosure, in S270, the computing device 100 may allocate tasks to the individual robot and the individual elevator. In an exemplary embodiment of the present disclosure, the computing device 100 may simultaneously perform task allocation to the robot and task allocation to the elevator.

In an exemplary embodiment of the present disclosure, if the order of the user is not completed in S280 (NO), the computing device 100 may repeatedly perform the above-mentioned S210 to S270, until the order of the user is completed.

In an exemplary embodiment of the present disclosure, if the order of the user is completed in S280 (YES), the computing device 100 may end the process.

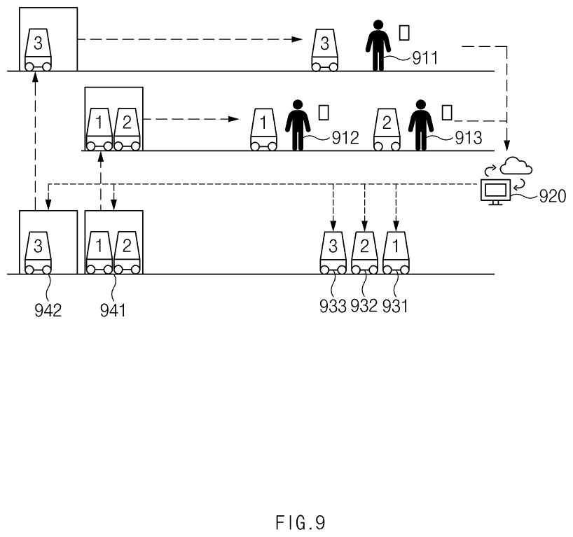

FIG. 9 is a drawing illustrating the entire process of allocating and delivering tasks to an elevator and a robot according to an exemplary embodiment of the present disclosure. Contents duplicated with the contents described above via FIG. 1, FIG. 2, FIG. 3, FIG. 4, FIG. 5, FIG. 6, FIG. 7, and FIG. 8 may be omitted from contents which will be described with reference to FIG. 9.

Referring to FIG. 9, a computing device 920 may receive information of an order from each of terminals of users 911, 912, and 913.

The computing device 920 may generate a plurality of tasks to be allocated to a plurality of elevators 941 and 942 and a plurality of robots 931, 932, and 933, on the basis of robot information, elevator information, and order information and may respectively allocate the plurality of tasks to a plurality of elevators 941 and 942 and a plurality of robots 931, 932, and 933.

The plurality of elevators 941 and 942 and the plurality of robots 931, 932, and 933 may perform the respectively allocated tasks.

For example, the first robot 931 and the second robot 932 may take the first elevator 941 on the first floor. The first elevator 941 may move the first robot 931 and the second robot 932 to the second floor. The first robot 931 and the second robot 932 which move to the second floor may deliver order products to the users 912 and 913, respectively.

For another example, the third robot 933 may take the second elevator 942 on the first floor. The second elevator 942 may move the third robot 933 to the third floor. The third robot 933 which moves to the third floor may deliver an order product to the user 911.

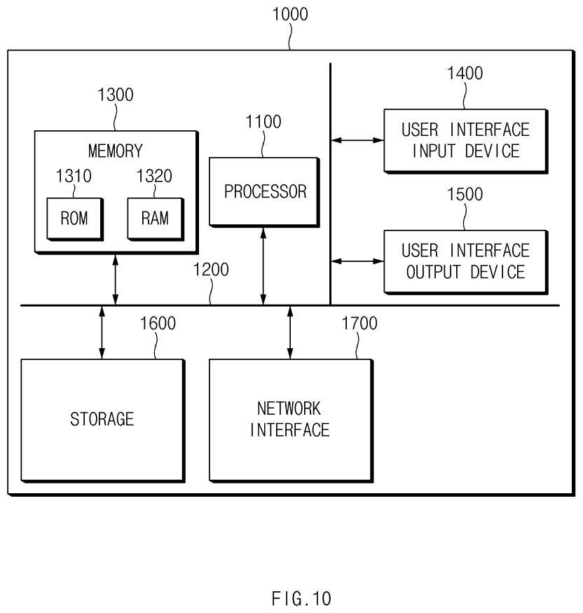

FIG. 10 illustrates a computing system according to an exemplary embodiment of the present disclosure. The computing system may correspond to some of the components of a computing system 100 for allocating tasks to an elevator and a robot, a robot server 200, an elevator server 300, and an order server 400 according to an exemplary embodiment of the present disclosure.

Referring to FIG. 10, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Thus, the operations of the method or the algorithm described in connection with the embodiments disclosed herein may be embodied directly in hardware or a software module executed by the processor 1100, or in a combination thereof. The software module may reside on a storage medium (i.e., the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

An exemplary embodiment of the present disclosure may apply a method for allowing a robot and an elevator to appropriately collaborate with each other to perform delivery using pieces of information of the robot, the elevator, and orders, thus reducing a delivery time and improving delivery service quality in a building.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Accordingly, various exemplary embodiments of the present disclosure are intended not to limit but to explain the technical idea of the present disclosure, and the scope and spirit of the present disclosure is not limited by the above embodiments. The scope of the present disclosure should be construed on the basis of the accompanying claims, and all the technical ideas within the scope equivalent to the claims should be included in the scope of the present disclosure.

What is claimed is:

1. An apparatus for allocating a plurality of tasks to an elevator and a robot, the apparatus comprising:
a memory;
a communication device; and
a processor operatively connected to the memory and the communication device,
wherein the processor:
obtains information of the elevator, information of the robot, and information of an order;
pre-processes the information of the elevator, the information of the robot, and the information of the order;
generates the plurality of tasks to be allocated to the elevator and the robot from the pre-processed information of the elevator, the pre-processed information of the robot, and the pre-processed information of the order, using a reinforcement learning model; and
respectively allocates the plurality of tasks to the elevator and the robot.

2. The apparatus of claim 1, wherein the processor manages the information of the elevator and the information of the robot as a list and updates and manages the list based on that a problem or an event occurs, based on obtaining the information of the elevator, the information of the robot, and the information of the order.

3. The apparatus of claim 1, wherein the processor sorts and manages the information of the order in a queue depending on a priority and a request time of the order, based on obtaining the information of the elevator, the information of the robot, and the information of the order.

4. The apparatus of claim 1,
wherein each of the information of the elevator and the information of the robot includes whether it is possible to operate the elevator and the robot, a location of the elevator and the robot, whether to proceed with work of the elevator and the robot, and a loadable amount of the elevator and the robot, and
wherein the information of the order includes a priority, an order product, an amount, a receiving place, and a delivery place of the order.

5. The apparatus of claim 1,
wherein the processor generates a worker data list which is a list of an available elevator and an available robot capable of working, based on the information of the elevator and the information of the robot, based on the pre-processing of the information of the elevator, the information of the robot, and the information of the order; and
wherein the processor generates a task data list including a task to be performed by each of the available elevator and the available robot, based on the information of the order.

6. The apparatus of claim 5, wherein the task data list includes an order number, a type of a performance target, a behavior of the performance target, a loaded item, and an amount for the item for each task.

7. The apparatus of claim 5, wherein the processor inputs the worker data list and the task data list to the reinforcement learning model to generate the plurality of tasks to be allocated to the available elevator and the available robot, based on the generating of the plurality of tasks to be allocated to the elevator and the robot.

8. The apparatus of claim 1, wherein the reinforcement learning model is pre-trained to allocate multiple tasks using a proximal policy optimization (PPO)-based deep reinforcement learning algorithm.

9. The apparatus of claim 8, wherein a reward function of the PPO-based deep reinforcement learning algorithm includes a total time delay (TTD) and a reward adjustment factor according to the TTD.

10. The apparatus of claim 1, wherein the processor updates a state in which the elevator and the robot currently perform the plurality of tasks, after generating the plurality of tasks to be allocated to the elevator and the robot.

11. A method for allocating a plurality of tasks to an elevator and a robot, the method comprising:
obtaining, by a processor, information of the elevator, information of the robot, and information of an order;
pre-processing, by the processor, the information of the elevator, the information of the robot, and the information of the order;
generating, by the processor, the plurality of tasks to be allocated to the elevator and the robot from the pre-processed information of the elevator, the pre-processed information of the robot, and the pre-processed information of the order, using a reinforcement learning model; and
respectively allocating, by the processor, the plurality of tasks to the elevator and the robot.

12. The method of claim 11, wherein the obtaining of the information of the elevator, the information of the robot, and the information of the order includes:
managing the information of the elevator and the information of the robot as a list; and
updating and managing the list, based on that a problem or an event occurs.

13. The method of claim 11, wherein the obtaining of the information of the elevator, the information of the robot, and the information of the order includes:
sorting and managing the information of the order in a queue depending on a priority and a request time of the order.

14. The method of claim 11,
wherein each of the information of the elevator and the information of the robot includes whether it is possible to operate the elevator and the robot, a location of the elevator and the robot, whether to proceed with work of the elevator and the robot, and a loadable amount of the elevator and the robot, and
wherein the information of the order includes a priority, an order product, an amount, a receiving place, and a delivery place of the order.

15. The method of claim 11, wherein the pre-processing of the information of the elevator, the information of the robot, and the information of the order includes:
generating a worker data list which is a list of an available elevator and an available robot capable of working, based on the information of the elevator and the information of the robot; and
generating a task data list including a task to be performed by each of the available elevator and the available robot, based on the information of the order.

16. The method of claim 15, wherein the task data list includes an order number, a type of a performance target, a behavior of the performance target, a loaded item, and an amount for the item for each task.

17. The method of claim 15, wherein the generating of the plurality of tasks to be allocated to the elevator and the robot includes:
inputting the worker data list and the task data list to the reinforcement learning model to generate the plurality of tasks to be allocated to the available elevator and the available robot.

18. The method of claim 11, wherein the reinforcement learning model is pre-trained to allocate multiple tasks using a proximal policy optimization (PPO)-based deep reinforcement learning algorithm.

19. The method of claim 18, wherein a reward function of the PPO-based deep reinforcement learning algorithm includes a total time delay (TTD) and a reward adjustment factor according to the TTD.

20. The method of claim 11, further comprising:
updating a state in which the elevator and the robot currently perform the plurality of tasks, after generating the plurality of tasks to be allocated to the elevator and the robot.
